(19) United States
(12) Patent Application Publication
(10) Pub. No.: US 2012/0004093 A1
(43) Pub. Date: Jan. 5, 2012

(54) HETEROGENEOUS CATALYST

(75) Inventors: Brian P. Reed, Corvallis, OR (US); Kevin E. Harris, Salem, OR (US); Nicholas Wannenmacher, Corvallis, OR (US)

(73) Assignee: THE STATE OF OREGON ACTING BY AND THROUGH THE STAT, Corvallis, OR (US)

(21) Appl. No.: 12/736,007

(22) PCT Filed: Mar. 3, 2009
(86) PCT No.: PCT/US2009/001425

§ 371 Date: Aug. 23, 2011

Related U.S. Application Data
(60) Provisional application No. 61/068,026, filed on Mar. 3, 2008.

(51) Int. Cl. B01J 35/02; B01J 29/04; B01J 21/06; B01J 23/755; B01J 23/745; B01J 21/10; B01J 23/06; B01J 23/72; B01J 23/50; B01J 21/04; B01J 23/75; B01J 23/14; B01J 23/42; B01J 23/44; B01J 23/46; B01J 37/08; B01J 21/16

(52) U.S. Cl. 502/80; 502/87; 502/100; 502/232; 502/325; 502/337; 502/338; 502/339; 502/340; 502/343; 502/345; 502/347; 502/349; 502/350; 502/352; 502/355

(57) ABSTRACT

A catalyst is provided, where the catalyst has an active surface that includes at least one nodular-structured (particulate) catalyst layer disposed on a support substrate, where the nodular-structured catalyst layer partially coats a surface of the support substrate. The invention further includes a fabrication method of the catalyst. The method includes depositing a catalyst precursor coating on a support substrate by heating a catalyst precursor solution on the support substrate, and further heating the catalyst precursor-coated substrate until a nodular-structured (particulate) catalyst is formed, where the nodular-structured catalyst layer partially coats a surface of the support substrate.

### FIELD OF THE INVENTION

The invention relates to catalysts. More particularly, the invention relates to catalysts with an active surface having nodular-structured catalysts disposed on portions of a support substrate.

### BACKGROUND

A catalyst in the same phase (usually liquid or gas solution) as the reactants and products is called homogeneous catalyst. Heterogeneous catalysts are those that act in different phases than the reactants. Most heterogeneous catalysts are solids placed in a liquid or gaseous reaction mixture. Heterogeneous catalysts are materials with the capability of adsorbing molecules of gases or liquids, for example, onto their surfaces. An example of heterogeneous catalysis is the use of finely divided platinum to catalyze the reaction of carbon monoxide with oxygen to form carbon dioxide. This reaction is used in catalytic converters mounted in automobiles to eliminate carbon monoxide from the exhaust gases.

Because heterogeneous catalysts often are used in high temperatures reactions, they are usually high melting-point materials. Heterogeneous catalysts are typically supported such that the catalyst is dispersed on a second material that enhances their effectiveness or minimizes their cost. Sometimes the support is merely a surface upon which the catalyst is disposed to increase the surface area. More often, the support and the catalyst interact, affecting the catalytic reaction. While there are many methods known in the art for providing a coating of one material upon another these procedures are usually developed in order to provide smooth, uniform coatings on the surfaces.

In recent years, biodiesel production has increased worldwide. The amount of biodiesel currently produced, however, can only accommodate a small fraction of the total amount of diesel consumed. Methods and processes to more efficiently produce biodiesel would enable greater amounts of biodiesel to be produced, thereby making biodiesel use more widespread.

Traditional methods of producing biodiesel use an acid or base as a homogeneous catalyst in batch-wise operations to convert triglycerides to esters. While these methods are simple to carry out they have undesirable consequences. The use of a homogeneous (liquid) catalyst requires careful washing or absorbent-based filtration of the biodiesel to remove any excess chemical catalyst before the biodiesel can be used. Washing the biodiesel generates large quantities of wastewater and is a costly process. In addition, water is introduced into the biodiesel, which may degrade its final quality. In the case of diatomaceous earth or resin based adsorption, large amounts of filter media are consumed at significant cost. Another undesirable consequence of homogeneously catalyzed methods is the contamination of the glycerol (a secondary product) with the chemical catalyst. While high quality glycerol could be a valuable product of the biodiesel synthesis operation, contaminated glycerol becomes a waste byproduct or is costly to purify.

Another significant problem in biodiesel production is the cost of feedstock. In particular, well-established methods of producing biodiesel rely on the use of a homogeneous consumable catalyst, such as aqueous sodium or potassium hydroxide, in a batch-wise operation. Generally these methods are restricted to the use of refined oils with low free fatty acid concentrations, generally only found in expensive feedstock, such as palm, canola, or soybean oil. Furthermore these methods use batch-wise operation, which causes significant variation in product quality and composition, necessitating continuous and costly product analysis.

To improve on the traditional methods of transesterification several non-catalytic and heterogeneous catalytic reaction systems have been proposed. The non-catalytic methods rely on much higher temperatures and pressures (e.g. 400 Celsius and 50 megapascals) than conventional biodiesel production schemes, and may include operation of the reaction in a supercritical state. Because transesterification is an equilibrium reaction in the absence of a catalyst, non-catalytic methods require a very large excess of alcohol to oil in order to “push” the final equilibrium to high conversion. This large excess may be up to 15-times what is necessary for complete reaction and results in high recovery costs. Additionally, high energy and specialized material demands exist when high pressure and high temperature conditions are required to promote transesterification. Furthermore, the extreme pressure and temperature conditions tend to break down the oil and esters into undesirable byproducts. For example, oils start to breakdown at about 200 degrees Celsius, though loss is minimal at this temperature. At 300 degrees Celsius oil breakdown becomes significant at residence times above 10 minutes, and by 400 degrees Celsius the oil is substantially degraded in only a minute or two. Additionally much of the desired product is destroyed, broken down into gaseous hydrocarbons or hydrogen. Any non-gaseous byproducts must be separated and removed from the biodiesel.

The heterogeneous catalytic methods of transesterification typically involve slightly elevated temperatures (e.g. about 60 degrees Celsius) with the catalyst consisting of mixtures of metal oxides or immobilized enzymes. The catalysts used in such systems may be in the form of powders, pellets, coated reactor walls, or any other typically used technique for contacting catalytic materials with reactants. However, traditional heterogeneous catalytic methods also have disadvantages. In particular, the catalyst is commonly immobilized inside or on the surface of a support material, which is typically alumina, zeolite, or a similar porous material. The immobilization of the catalyst often makes catalyst production expensive and difficult; despite high apparent activity in some catalysts, these methods generally suffer from long reaction times and low yields. It is not uncommon to have a reaction time of more than one hour with a yield of less than 60%.

Often the most desirable catalytic material is not compatible with the support substrate, and in these cases a less active form of the catalyst is used. For example resinous support materials have been impregnated with organo-metalic tin compounds, which do catalyze transesterification, but require many hours for reaction and give low conversions. Some of the heterogeneous catalysts being developed for biodiesel are extremely fine particles and are mixed in with the alcohol and oil to form a slurry. After the reaction is complete the catalyst must be removed by rigorous filtration, a costly and time consuming endeavor.

Accordingly, there is a need to develop a method of biodiesel production, which can exploit the synergistic effect of combining high temperature and pressure with a heterogeneous catalyst/s. Further there is a need to develop a heterogeneous catalyst having a high activity and designed to be used at the elevated temperatures and pressures which will be present in the envisioned system. The use of high temperature and pressure would speed the reaction and enhance the activity of a heterogeneous catalyst, while the catalyst would reduce the necessity for extreme reaction conditions and boost the transesterification reaction. Such a method would overcome the difficulties of thermally degraded oil, reliance on expensive refined or pre-treated feedstocks, necessity of large alcohol to oil ratios, and long reaction times, not to mention the problems associated with traditional homogeneously catalyzed biodiesel.

### SUMMARY OF THE INVENTION

The present invention provides a catalyst having an active surface that includes at least one nodular-structured catalyst layer disposed on a support substrate, where the nodular-structured catalyst layer partially coats a surface of the support substrate.

According to one aspect of the invention, the support substrate can include iron, stainless steel, nickel, nickel alloy, silicon, zirconium, copper, lead, zinc, titanium, alumina, silicates, clays, or zeolites and may or may not be catalytically active.

In another aspect of the invention, the nodular-structured catalyst can be at least partially oxidized lead, tin, cobalt, nickel, silver, platinum, palladium, zinc, silicon, rhodium, iron, magnesium or any alloy thereof.

In a further aspect, the active surface can be at least a portion of a surface of a reactor structure.

In yet another aspect of the invention, the support material can be a particle having a size in the range of 1 μm to 10,000 μm.

According to one aspect, the nodular-structured catalyst can be a nudule having a size in a range of 0.1 μm to 100 μm.

According one aspect, the invention includes a fabrication method of the catalyst by depositing a catalyst precursor coating on a support substrate by heating a catalyst precursor solution on the support substrate, and then further heating the catalyst precursor-coated substrate until a nodular-structured catalyst layer is formed, where the nodular-structured catalyst layer partially coats a surface of the support substrate.

According to one aspect of the method, the catalyst precursor solution is a salt solution. Here, the salt solution can include chlorides, sulfates, sulfites, hyperchlorites, chlorites, chlorates, perchlorates, and phosphates of the catalyst metals of interest. In a further aspect, the salt solution can be a tin chloride salt, where the tin chloride salt has a concentration in a range of 0.5 to 2 molar.

According to another aspect of the method, the support substrate is at least a portion of a surface of a reactor structure.

In a further aspect of the method, the support substrate is a particle having a size in the range of 1 μm to 10,000 μm.

In yet another aspect of the method, the support substrate is selected from the group consisting of iron, stainless steel, nickel, nickel alloy, silicon, zirconium, copper, lead, zinc, titanium, alumina, silicates, clays, and zeolites.

According to another aspect of the method, the nodular-structure catalyst can be at least partially oxidized lead, tin, cobalt, nickel, silver, platinum, palladium, zinc, silicon, rhodium, iron, magnesium or any alloy thereof.

In a further aspect of the method, the support substrate is degreased in a caustic solution, where the caustic solution can be sodium hydroxide or potassium hydroxide or any degreasing agent as is known in the art.

According to one aspect of the method, the support substrate is cleaned and stripped of any surface oxides using an acid that is compatible with the substrate. Here, the acid can be hydrochloric acid, wherein the hydrochloric acid has a concentration in a range of 4 to 8 molar.

In a further aspect of the method, heating the catalyst precursor solution on the support substrate evaporates water in the catalyst precursor solution.

In yet another aspect of the method, the saturated catalyst precursor solution is heated at a temperature having a range of 90 to 200 degrees Celsius for a duration in a range of 1 to 240 minutes.

In another aspect of the method, the catalyst-coated support substrate is heated at a temperature having a range of 150 to 1000 degrees Celsius for a duration in a range of 5 to 240 minutes.

According to yet another aspect of the method, the nodular-structured catalyst layer partially coating the support substrate surface is washed with water to remove free salts and heated at a temperature of about 200 degrees Celsius to dry and oxidize, where the oxidizing is optional.

### BRIEF DESCRIPTION OF THE FIGURES

The objectives and advantages of the present invention will be understood by reading the following detailed description in conjunction with the drawing, in which:

FIGS. 1(a)-1(b) show optical microscopic images of stainless steel powder and stainless steel powder coated with tin oxide, respectively, according to the current invention.

FIGS. 2(a)-2(b) show a scanning electron micrographs of a particle of the stainless steel support substrate, and a particle of the stainless steel support substrate coated with tin oxide, respectively, according to the current invention.

FIGS. 3(a)-3(b) show surface analysis spectrographs of a stainless steel substrate and a tin oxide coated stainless steel, respectively, according to the current invention.

FIGS. 4-5 show the steps of methods of fabricating the catalyst, according to the current invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The current invention is a catalyst having an active surface that includes at least one nodular-structured catalyst disposed on a support substrate. The nodular-structured catalyst partially coats the surface of the support substrate. The catalyst is produced using a salt-metal fusion process, where the activity of the resultant catalyst surface is a product of both its physical and chemical properties. Specifically the activity of the catalyst surface depends on the chemical composition of the support substrate as well as the deposited catalyst. The activity also depends on the physical properties of the deposited catalyst and substrate surfaces, such as roughness, inhomogeneity, and exposed interfaces between the deposited catalyst and substrate material. The salt-metal fusion process of the current invention creates a model catalyst because it produces a rough, patchy, and active surface.

The current invention is useful due to its simplicity and its ability to fuse materials that, until now, resist conventional plating methods such as electroplating, which is useful for uniformly coating individual large pieces but is impractical for small structures requiring rough, patchy surfaces.

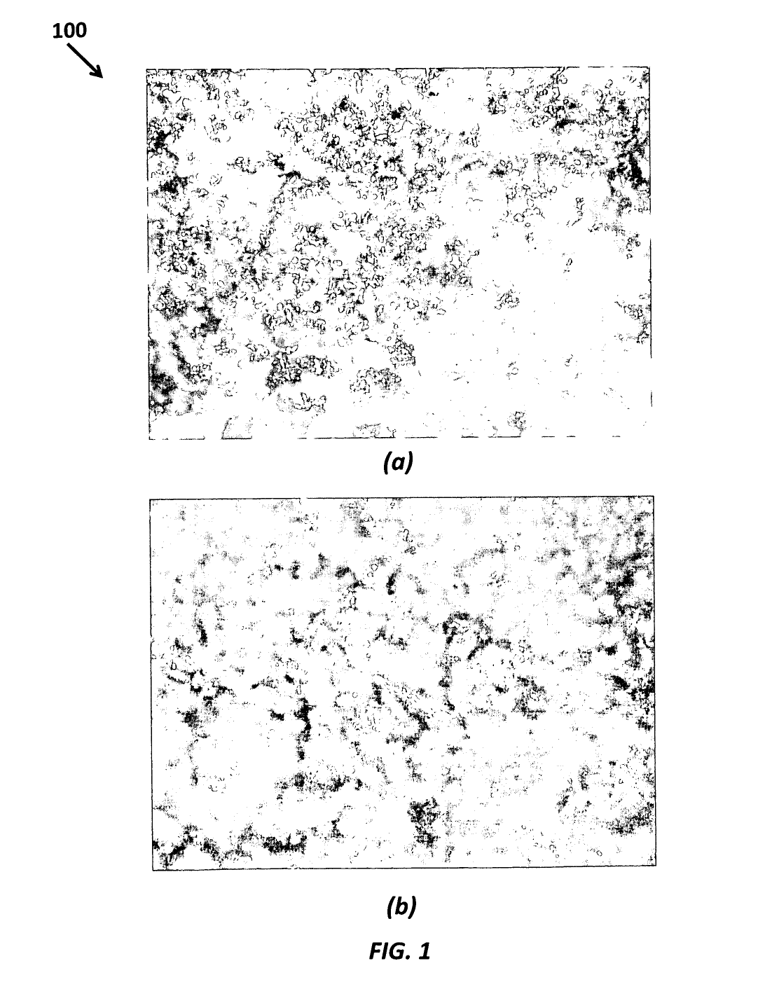

Referring now to the Figures, FIGS. 1(a) and 1(b) show optical microscopic images 100, where FIG. 1(a) shows an optical microscopic image of stainless steel powder and FIG. 1(b) shows an optical microscopic image of the stainless steel powder coated with tin oxide using salt metal fusion according to the current invention. FIG. 1(b) shows the plated stainless steel powder has a more 3-dimensional surface than the stainless steel powder of FIG. 1(a), where the bright reflective stainless steel has become mottled with tin oxide deposits.

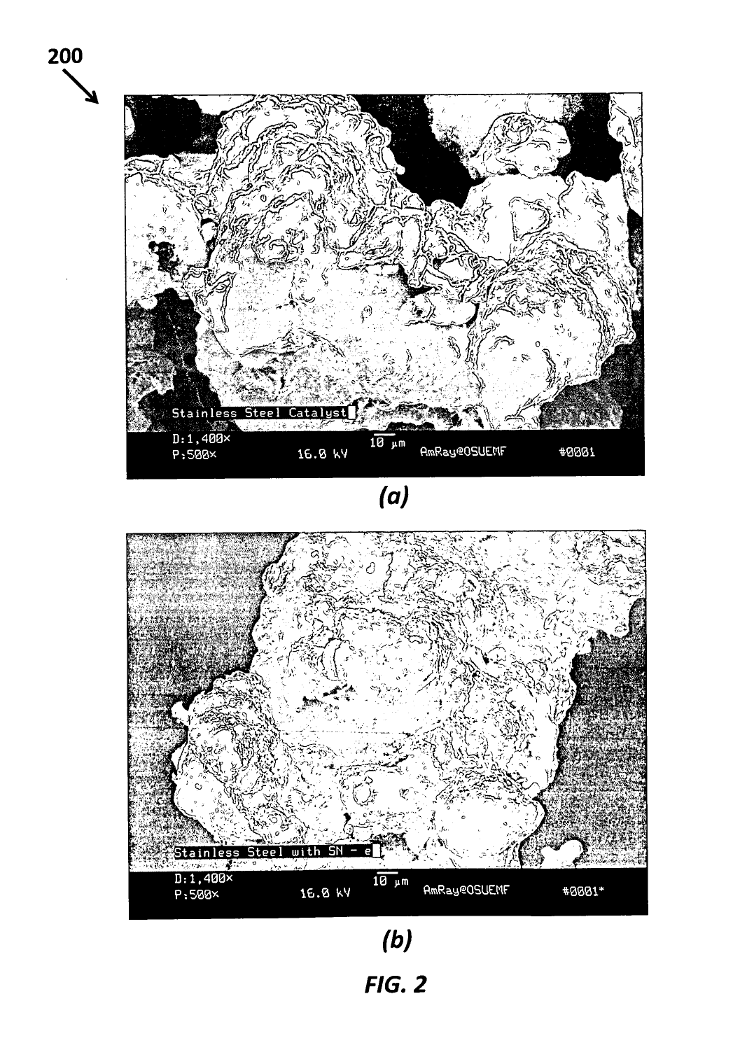

FIGS. 2(a) and 2(b) show a scanning electron micrographs 200, where FIG. 2(a) shows a scanning electron micrograph of a particle of the stainless steel support substrate, and FIG. 2(b) shows a scanning electron micrograph of the particle of the stainless steel support substrate coated with tin oxide produced using the salt-metal fusion process according to the current invention. As shown, the untreated stainless steel support substrate in FIG. 2(a) is relatively smooth with respect to the resultant catalyst in FIG. 2(b), which shows a rough, nodular-structured catalyst partially coating the surface of the support substrate.

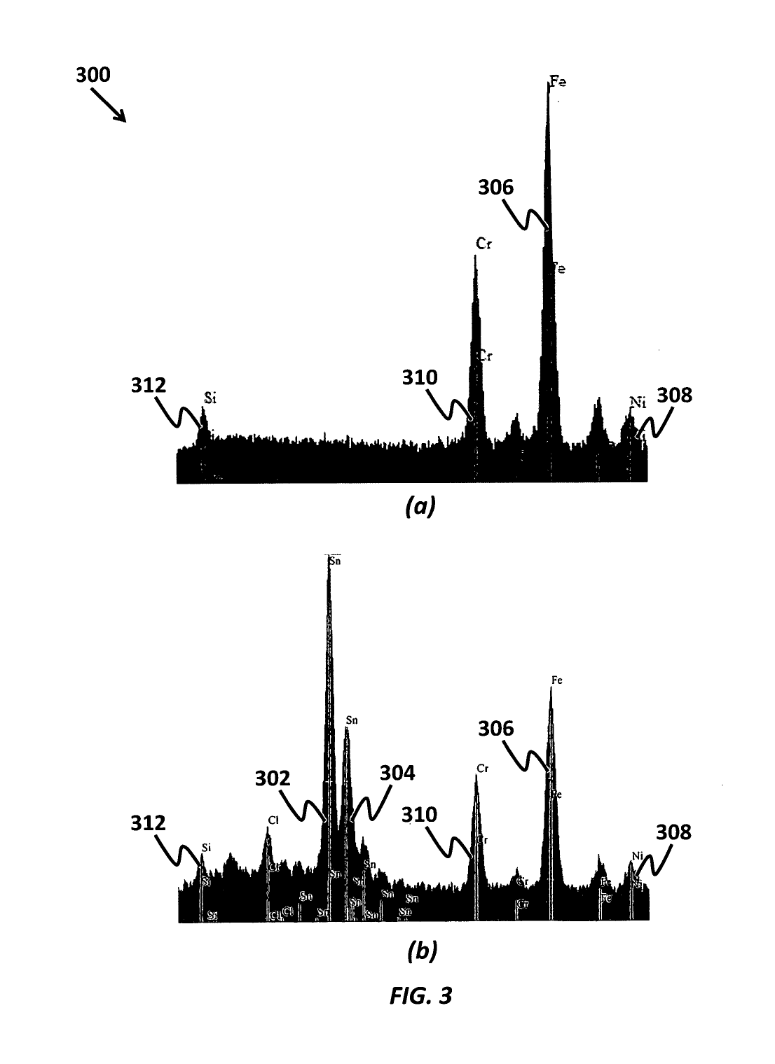

FIGS. 3(a) and 3(b) show surface analysis spectrographs 300, where FIG. 3(a) shows a surface analysis spectrograph of a stainless steel substrate and FIG. 3(b) shows a surface analysis spectrograph of tin oxide coated stainless steel produced with salt-metal fusion process, according to the current invention. FIG. 3(b) shows the large tin peaks 300/302, indicating a substantial amount of tin/tin oxide 300/302 on the surface of the catalyst. However peaks for iron, nickel, chromium, and even silicon are still present which illustrates that the substrate has not been completely covered.

As shown in FIGS. 1-3, the present invention provides a catalyst having an active surface that includes at least one nodular-structured catalyst disposed on a support substrate, where the nodular-structured catalyst partially coats a surface of the support substrate, where the support substrate can include iron, stainless steel, nickel, nickel alloy, silicon, zirconium, copper, lead, zinc, titanium, alumina, silicates, clays, or zeolites, and the nodular-structured catalyst can be at least partially oxidized lead, tin, cobalt, nickel, silver, platinum, palladium, zinc, silicon, rhodium, iron, magnesium or any alloy thereof. The support material can be a particle having a size in the range of 1 μm to 10,000 μm, and the nodular-structured catalyst can be a particle having a size in a range of 0.1 μm to 100 μm.

In a further aspect, the active surface can be at least a portion of a surface of a reactor structure, for example tubular reactors or micro-channel reactors.

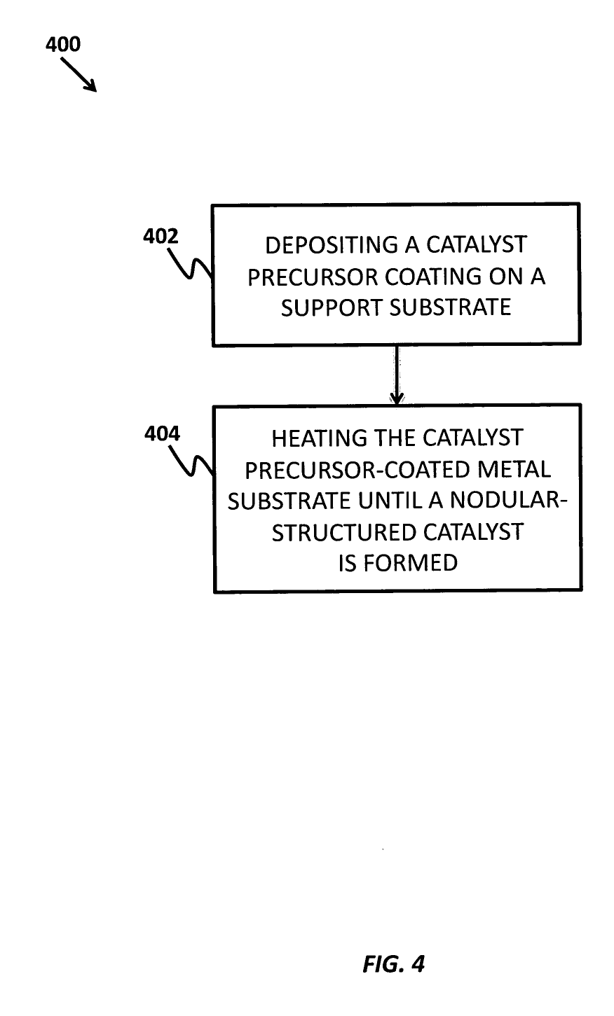

According to one embodiment of the invention, a method of fabricating the catalyst 400 is shown in FIG. 4 that includes depositing a catalyst precursor coating on a support substrate 402 by heating a catalyst precursor solution on the support substrate, and further heating the catalyst precursor-coated metal substrate until a nodular-structured catalyst is formed 404, where the nodular-structured catalyst partially coats a surface of the support substrate.

The invention includes placing a desired catalyst precursor into a solution that includes water, where the catalyst precursor can include a salt of a metal to be used as a catalyst. The solution is used to coat a substrate forming a catalyst precursor solution coated substrate, which is heated to remove the water from the salt solution, providing a substrate that is coated with catalyst precursor. The catalyst precursor coated substrate is further heated to bond the catalyst metal to the substrate to provide a nodular-structured catalyst coated substrate.

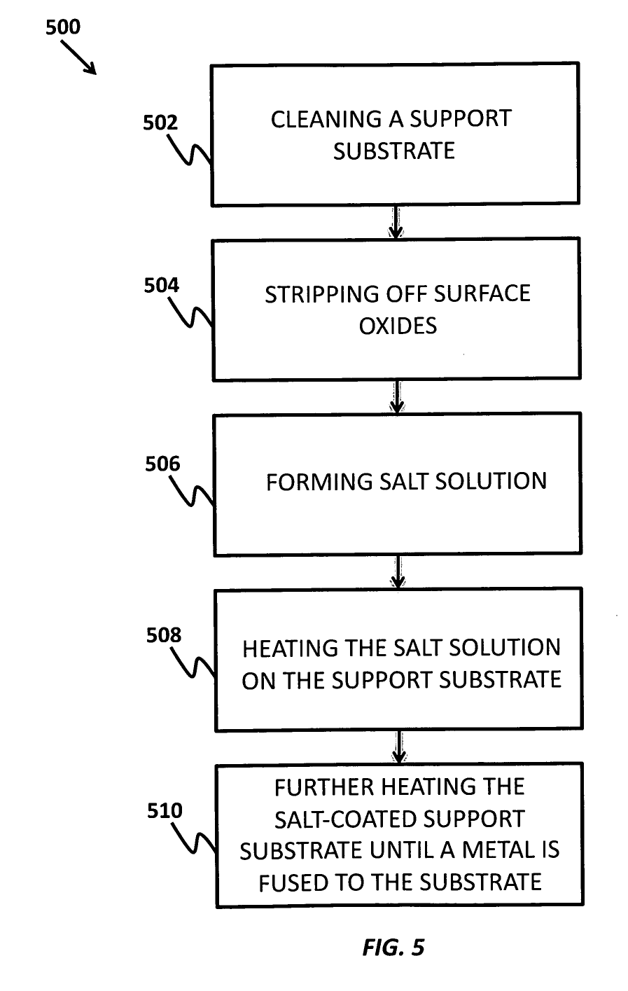

According to one embodiment, the invention is a method of fabricating a catalyst, where FIG. 5 shows the fabrication steps 500 for the catalyst that includes cleaning a support substrate 502 in a sodium hydroxide solution, where for example the stainless steel surface to be plated is first degreased in a caustic solution, where the caustic solution can be sodium hydroxide or potassium hydroxide solution, then the cleaned substrate is stripped of surface oxides 504 using hydrochloric acid or an acid that is compatible with the support substrate, for example the acid can be hydrochloric acid, where the hydrochloric acid has a concentration in a range of 4 to 8 molar. A salt solution is formed 506 by dissolving a salt in water, for example, tin chloride salt is dissolved in water. The salt solution on the support substrate is heated 508 to evaporate the water and to form a concentrated salt coating on the support substrate, for example heated at a temperature having a range of 90 to 200 degrees Celsius for a duration in a range of 1 to 240 minutes. It is understood that the salt may or may not be saturated when the heating begins, rather the heating can bring the salt solution that is coating the substrate to a saturation point. The salt-coated support substrate is further heated 510 until a metal is fused to the surface, where the metal reacts with the support substrate and may simultaneously be partially oxidized, and a coating of the metal and salt is formed on said support substrate, for example heated at a temperature having a range of 150 to 1000 degrees Celsius for a duration in a range of 5 to 240 minutes. One important aspect of this heating phase is the catalyst becomes fused to the substrate due to a combination of high temperature diffusion and the reactions caused by the relatively harsh conditions at the interface between the catalyst-metal-salt and the substrate. The coated support substrate is cooled 512, and the cooled coated support substrate is washed in water 514 to remove free salts, where a porous structure is provided. Finally, the washed metal oxide coated substrate is heated 516 to remove water there from, where a catalyst having a rough-surface morphology structure is provided, where the heating can by at a temperature of about 200 degrees Celsius to dry the catalyst and optionally oxidize the catalyst.

During heating, the salt solution coating the substrate becomes saturated as the water evaporates. In general, salts, especially those containing halides are very corrosive when concentrated and at high temperatures. Even materials resistive to chemical attack, such as stainless steel will be acted upon. As the substrate coated with catalyst precursor is heated, there will be physical and chemical events occurring leading to the roughening of the substrate surface and the deposition of the metal of interest both as a salt, and as a metal onto and/or into the surface of the substrate itself. Further increasing the temperature serves to fuse the deposited metal into the substrate material. The metal salts residues are then removed from the substrate by repeated washing, leaving a rough nodular coating of catalyst fused on the substrate. It is understood that the catalyst is the final form of the metal of interest deposited on a suitable substrate, where the form of the metal can be non-oxidized, partially oxidized or fully oxidized. Further, it is understood that the substrate is the physical support material to which the major catalytically active material/s have been fused, where the substrate may or may not have catalytic activity on its own. A catalyst precursor includes a salt of the metal of interest, which is placed into solution and applied to the substrate.

According to one aspect, the catalyst precursor solution is a salt solution. Here, the salt solution can include chlorides, sulfates, sulfites, hyperchlorites, chlorites, chlorates, perchlorates, and phosphates of the desired metal or metals. In a further aspect, the salt in the solution can be a tin chloride salt, where the tin chloride salt has a concentration in a range of 0.5 to 2 molar.

According to one aspect, the present invention can be directed to the use of deposited tin oxide as a catalyst in biodiesel production, where the tin oxide can be deposited on a powdered stainless steel substrate positioned in a packed bed configuration and operated below, at, or above the critical point of the chosen alcohol. Tin oxide can be deposited on the reaction surface of tubular reactors as well as micro-channel reactors by use of this method. The deposition of tin oxide can be used for the conversion of glycerides to esters. Biodiesel production according to the present invention reduces or eliminates many of the difficulties of traditional high temperature or supercritical non-catalytic methods, and substantially reduces the disadvantages of traditional heterogeneous catalytic methods of transesterification. In particular, advantages of the present invention include substantially improving the reaction times and ease of catalyst preparation when compared to existing heterogeneous catalyst methods. More specifically, the effective range of operating conditions (temperature and pressure) for the catalyst as used in the packed bed configuration is quite broad. Temperatures may be between 200 and 350 degrees Celsius and pressures may be from 1 to 30 megapascals. The conditions of temperature and pressure may be chosen so as to provide operation in sub or supercritical regimes, and can produce high yields of biodiesel esters under both conditions. By adjusting reaction conditions biodiesel may be produced under mild conditions in a period of several minutes or under more harsh conditions in a matter of seconds depending on the needs of process and the available infrastructure.

In this aspect, the combination of a heterogeneous tin oxide catalyst with high temperature and high pressure, moderate to high temperatures and pressures, or supercritical conditions provides biodiesel production with low reactor residence times, reduced excess alcohol usage, reduced severity of the operating conditions, a simple reactor design, and allows for the continuous reuse of a fixed, low cost and easy to produce catalyst while maintaining high yields and clean, uncontaminated products.

According to another aspect, the invention provides a fabrication method of a heterogeneous catalyst—the metal-salt fusion deposition and subsequent oxidation of tin metal on a stainless steel substrate. In another aspect, the catalyst can be applied to a packed bed or flow channel reactor. In a further aspect, the operation of this reactor is useful under conditions below, at, or above the critical temperature or pressure of selected alcohol for the transesterification of triglycerides. The combination of these inventions provides higher yields, faster conversion, and uses much lower feed ratios of alcohol to oil than any similar reported transesterification process or method reported in literature.

The heterogeneous catalyst described FIG. 5, is well suited for use in powder packed bed and flow channel reactors. According to one embodiment of the invention, process-inert and relatively inexpensive stainless steel reaction surfaces can be plated with tin oxide catalyst to provide the nodular-structured catalyst, for example.

The current invention can transform the current practices for manufacturing biodiesel. To date, commercially produced biodiesel is being made by using chemical reactants that later need to be removed from the product streams. The cleaning of these product streams generates large waste streams. The methods in this invention don't require the introduction of anything into the system that can't be recycled back into the process. Also, unlike other alternative bench scale based biodiesel processes, which are not scaleable and/or are batch base systems, this process has the potential to be a continuous, high volume, and easily scaleable system.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example: the conversion of carboxylic acids to esters, the manufacture of polymeric or paraffinic compounds or the production of methane or hydrogen from a variety of feedstocks.

All such variations are considered to be within the scope and spirit of the present invention as defined by the following claims and their legal equivalents.

What is claimed:

1. A catalyst comprising an active surface, wherein said active surface comprises at least one nodular-structured catalyst layer disposed on a support substrate, wherein said nodular-structured catalyst layer partially coats a surface of said support substrate.

2. The catalyst of claim 1, wherein said support substrate is selected from the group consisting of iron, stainless steel, nickel, nickel alloy, silicon, zirconium, copper, lead, zinc, titanium, alumina, silicates, clays, and zeolites.

3. The catalyst of claim 1 wherein said nodular-structured catalyst is selected from the group consisting of at least partially oxidized lead, tin, cobalt, nickel, silver, platinum, palladium, zinc, silicon, rhodium, iron and magnesium.

4. The catalyst of claim 3, wherein said nodular-structured catalyst is an alloy of said at least partially oxidized metal.

5. The catalyst of claim 1, wherein said active surface is at least a portion of a surface of a reactor structure.

6. The catalyst of claim 1, wherein said support material is a particle having a size in the range of 1 μm to 10,000 μm.

7. The catalyst of claim 1, wherein said nodular-structured catalyst is a particle having a size in a range of 0.1 μm to 100 μm.

8. A method of fabricating a catalyst comprising:
a. depositing a catalyst precursor coating on a support substrate by heating a catalyst precursor solution on said support substrate; and
b. further heating said catalyst precursor-coated support substrate until a nodular-structured catalyst is formed, wherein said nodular-structured catalyst partially coats a surface of said support substrate.

9. The method of claim 8, wherein said catalyst precursor is a salt solution.

10. The method of claim 9, wherein said salt in said salt solution is metal salt selected from the group consisting of chlorides, sulfates, sulfites, hyperchlorites, chlorites, chlorates, perchlorates, and phosphates.

11. The method of claim 9, wherein said salt in said salt solution is tin chloride salt.

12. The method of claim 11, wherein said tin chloride salt has a concentration in a range of 0.5 to 2 molar.

13. The method of claim 8, wherein said support substrate is at least a portion of a surface of a reactor structure.

14. The method of claim 8, wherein said support substrate is a particle having a size in the range of 1 μm to 10,000 μm.

15. The method of claim 8, wherein said support substrate is selected from the group consisting of iron, stainless steel, nickel, nickel alloy, silicon, zirconium, copper, lead, zinc, titanium, alumina, silicates, clays, and zeolites.

16. The method of claim 8, wherein said nodular-structured catalyst is selected from the group consisting of at least partially oxidized lead, tin, cobalt, nickel, silver, platinum, palladium, zinc, silicon, rhodium, iron and magnesium.

17. The method of claim 16, wherein said nodular-structured catalyst is a partially oxidized alloy of said metal.

18. The method of claim 8, wherein said support substrate is degreased in a caustic solution, wherein said caustic solution is selected from the group consisting of sodium hydroxide and potassium hydroxide.

19. The method of claim 8, wherein said support substrate is cleaned and stripped of any surface oxides using an acid that is compatible with said substrate.

20. The method of claim 19, wherein said acid is hydrochloric acid, wherein said hydrochloric acid has a concentration in a range of 4 to 8 molar.

21. The method of claim 8, wherein said heating of said catalyst precursor solution on said support substrate evaporates water in said catalyst precursor solution.

22. The method of claim 8, wherein said saturated catalyst precursor solution is heated at a temperature having a range of 90 to 200 degrees Celsius for a duration in a range of 1 to 240 minutes.

23. The method of claim 8, wherein said catalyst precursor-coated support substrate is heated at a temperature having a range of 150 to 1000 degrees Celsius for a duration in a range of 5 to 240 minutes.

24. The method of claim 8, wherein said nodular-structured catalyst layer partially coating said support substrate surface is washed with water to remove free salts and heated at a temperature of about 200 degrees Celsius to dry and oxidize, wherein said oxidizing is optional.
